(19) United States
(12) Patent Application Publication
(10) Pub. No.: US 2011/0210963 A1
(43) Pub. Date: Sep. 1, 2011

(54) SYSTEM AND METHOD FOR DISPLAYING THREE DIMENSIONAL IMAGES

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/756,184

(22) Filed: Apr. 8, 2010

(30) Foreign Application Priority Data
Feb. 26, 2010 (TW) 99105741

(51) Int. Cl. G06T 15/00; H04N 13/04; H04N 13/02

(52) U.S. Cl. 345/419; 348/51; 348/46; 348/E13.075; 348/E13.074

(57) ABSTRACT

A system and method for displaying three dimensional (3D) images projects a current image on a screen to obtain an original 3D image by a 3D projector, detects a movement of a user by a 3D camera at each time interval, and transfers coordinate alterations of the user to a computer. The computer adjusts a position of the current image on a display according to the coordinate alteration of the user, and transfers the adjusted current image to the 3D projector. Then, the 3D projector projects the adjusted current image on the screen, so as to obtain a new 3D image on the screen.

### BACKGROUND

1. Technical Field

Embodiments of the present disclosure relate to image display technology, and particularly to a system and a method for displaying three dimensional (3D) images.

2. Description of Related Art

Currently, images may be projected on a screen by a 3D projector to generate 3D images on the screen. A user can view the 3D images on the screen using a pair of special 3D glasses. However, the status of the 3D images on the screen cannot be changed according to the movement of a user. Therefore, a prompt and efficient method for displaying 3D images is desired.

### BRIEF DESCRIPTION OF THE DRAWINGS

FIG. 1 is a schematic diagram of one embodiment of a system for displaying 3D images.

FIG. 2 is a schematic diagram of one embodiment of adjusting a position of a 3D image on a screen according to a movement of a user.

FIG. 3 is a flowchart of one embodiment of a method for displaying 3D images.

### DETAILED DESCRIPTION

All of the processes described below may be embodied in, and fully automated via, functional code modules executed by one or more general purpose computers or processors. The code modules may be stored in any type of readable medium or other storage device. Some or all of the methods may alternatively be embodied in specialized hardware. Depending on the embodiment, the readable medium may be a hard disk drive, a compact disc, a digital video disc, or a tape drive.

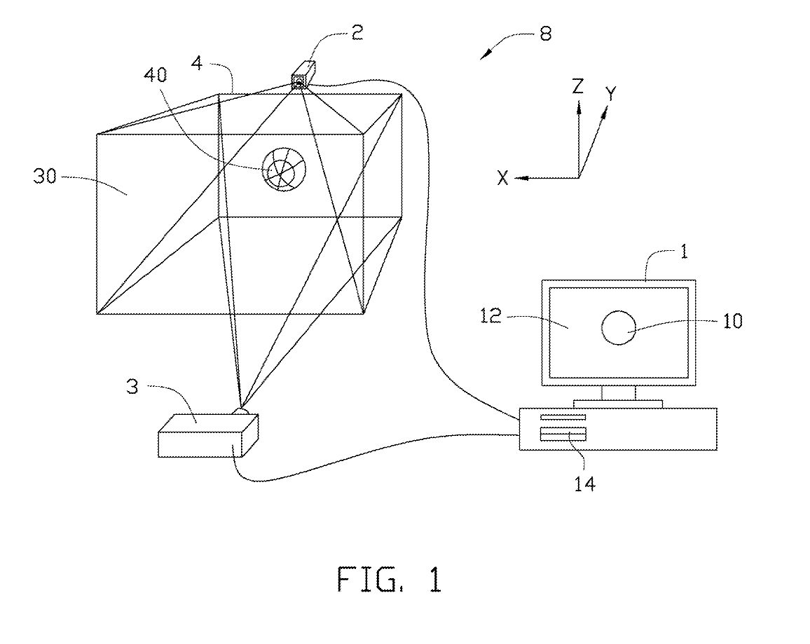

FIG. 1 is a schematic diagram of one embodiment of a system 8 for displaying 3D images. In one embodiment, the system 8 includes a computer 1, a 3D camera 2, a 3D projector 3, and a screen 4. The system 8 may be used to adjust a position of a 3D image on the screen 4 according to a movement of a user. A detailed description will be given in the following paragraphs.

In one embodiment, the computer 1 is electronically connected to the 3D camera 2 and the 3D projector 3. Depending on the embodiment, the 3D camera 2 may be a time of flight (TOF) camera, for example. The computer 2 includes a display 12 to show two dimensional (2D) images. In one embodiment, the display 12 may be a liquid crystal display (LCD) or a cathode ray tube (CRT) display, for example.

The computer 2 further includes a storage device 14 to store various information, such as a 2D animation set by a multimedia platform (e.g., ADOBE FLASH). In one embodiment, the 3D projector 3 may be used to project each image of the 2D animation on the screen 4, to generate a 3D image. Then, the 3D images on the screen 4 may be viewed using a pair of special 3D glasses.

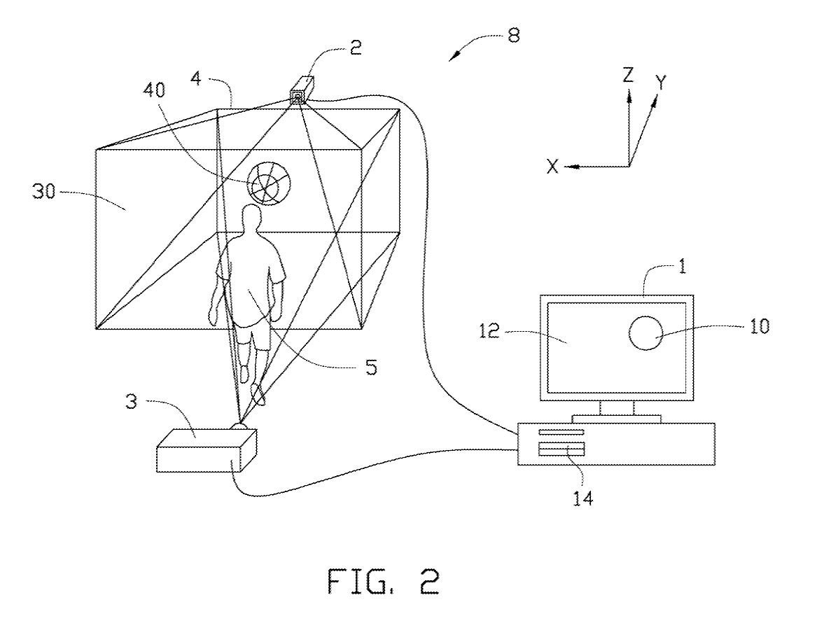

The 3D camera 3 may be used to detect the movement of a user 5 (as shown in FIG. 2), and transfer coordinate alterations of the user 5 to the computer 1. The computer 1 adjusts a position of a current image 10 on the display 12 according to the coordinate alteration of the user. Then, the 3D projector 3 projects the adjusted current image on the screen 4 to obtain a new 3D image on the screen 4. A detailed description will be given in the following paragraphs.

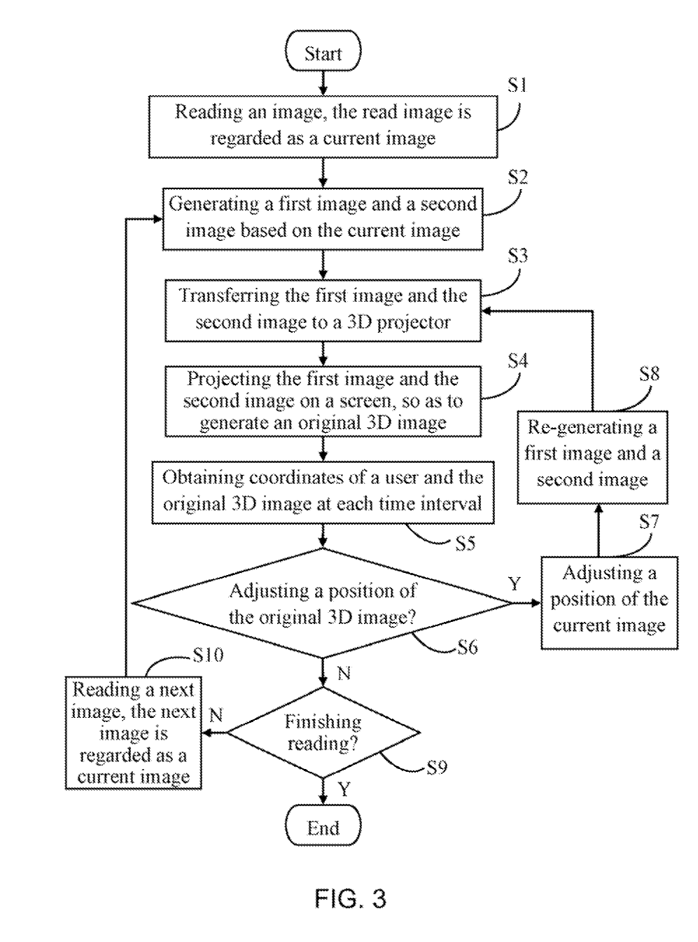

FIG. 3 is a flowchart of one embodiment of a method for displaying 3D images. Depending on the embodiment, additional blocks may be added, others removed, and the ordering of the blocks may be changed.

In block S1, the computer 1 reads each image from a two dimensional (2D) animation stored in the storage device 14, the read image is regarded as a current image 10, and displays the current image 10 on the display 12.

In block S2, the computer 1 generates a first image and a second image based on the current image 10. In one embodiment, the first image may be a virtual image obtained by a left eye of a user who views the current image 10, and the second image may be a virtual image obtained by a right eye of the user who views the current image 10.

In block S3, the computer 1 transfers the first image and the second image to the 3D projector 3.

In block S4, the 3D projector 3 projects the first image and the second image on the screen 4 to generate an original 3D image 40, and obtains a 3D virtual scene 30 including the user 5 and the original 3D image 40.

In block S5, the 3D camera 2 obtains coordinates of the user 5 and the original 3D image 40 at each time interval, such as 0.03 seconds, and calculates a distance between the coordinates of the user 5 and the coordinates of the original 3D image 40. In one embodiment, the coordinates of the user 5 are known as the coordinates of the user 5 in the 3D virtual scene 30, and the coordinates of the original 3D image 40 are known as the coordinates of the original 3D image 40 in the 3D virtual scene 30.

In block S6, the 3D camera 2 determines if a position of the original 3D image 40 on the screen 4 needs to be adjusted according to the calculated distance. For example, if the calculated distance is less than a preset value, such as 2 cm, the 3D camera 2 determines that the position of the original 3D image 40 on the screen 4 needs to be adjusted, then the procedure goes to block S7. If the calculated distance is greater than or equal to the preset value, the 3D camera 2 determines that the position of the original 3D image 40 on the screen 4 does not need to be adjusted, then the procedure goes to block S9.

In block S7, the 3D camera 2 transfers a coordinate alteration of the user 5 to the computer 1. The computer 1 stops displaying the original 3D image 40, and adjusts a position of the current image 10 on the display of the computer 1 according to the coordinate alteration of the user 5, then the procedure goes to block S8. In one embodiment, the coordinate alteration of the user 5 is a difference between the coordinates of a current position of the user 5 and the coordinates of a previous position of the user 5 in the 3D virtual scene 30. A detailed description is shown as follows.

First, the computer 1 obtains a movement direction and a movement speed of the user 5 according to the coordinate alteration of the user 5. In one embodiment, the movement speed of the user 5 is calculated by dividing the coordinate alteration of the user 5 by the time interval.

For example, the computer 1 determines that the movement direction of the user 5 is left, if the coordinate alteration of the user 5 in the X-axis is positive, or determines that the movement direction of the user 5 is right, if the coordinate alteration of the user 5 in the X-axis is negative.

The computer 1 determines that the movement direction of the user 5 is forward, if the coordinate alteration of the user 5 in the Y-axis is positive, or determines that the movement direction of the user 5 is backward, if the coordinate alteration of the user in the Y-axis is negative.

The computer 1 determines that the movement direction of the user 5 is up, if the coordinate alteration of the user 5 in the Z-axis is positive, or determines that the movement direction of the user 5 is down, if the coordinate alteration of the user in the Z-axis is negative.

Second, the computer 1 adjusts the coordinates or a size of the current image 10 on the display of the computer 1 according to the movement direction and the movement speed of the user 5.

For example, the computer 1 moves the current image 10 right with the movement speed of the user 5 if the movement direction of the user 5 is left, or moves the current image 10 left with the movement speed of the user 5 if the movement direction of the user 5 is right.

The computer 1 moves the current image 10 down with the movement speed of the user 5 if the movement direction of the user 5 is up, or moves the current image 10 up with the movement speed of the user 5 if the movement direction of the user 5 is down.

The computer 1 zooms in the current image 10 if the movement direction of the user 5 is forward, or zooms out the current image 10 if the movement direction of the user 5 is backward.

In block S8, the computer 1 re-generates a first image and a second image based on the adjusted current image, transfers the re-generated first image and second image to the 3D projector 3 to execute block S3-S4, to generate a new 3D image on the screen 4, and delete the original 3D image 40.

In block S9, the computer 1 determines if all the images of the 2D animation are finished reading. If any image of the 2D animation is not read, the procedure goes to block S10. If all the images of the 2D animation are read, the procedure ends.

In block S10, the computer 1 reads a next image from the 2D animation, the next image is regarded as a current image, and the procedure returns to block S2.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computing system for displaying three dimensional (3D) images, the computing system comprising a computer, a 3D camera, a 3D projector, and a screen, wherein:
the computer is operable to read each image from a two dimensional (2D) animation stored in a storage device of the computer, the read image being regarded as a current image, display the current image on a display of the computer, generate a first image and a second image based on the current image, and transfer the first image and the second image to the 3D projector, the first image being a virtual image obtained by a left eye of a user, the second image being a virtual image obtained by a right eye of the user;
the 3D projector is operable to project the first image and the second image on the screen to generate an original 3D image;
the 3D camera is operable to obtain coordinates of the user and the original 3D image at each time interval, calculate a distance between the coordinates of the user and the original 3D image, determine if a position of the original 3D image on the screen needs to be adjusted according to the calculated distance, and transfer a coordinate alteration of the user to the computer if the position of the original 3D image needs to be adjusted;
the computer is further operable to stop displaying the original 3D image, adjust a position of the current image on the display of the computer according to the coordinate alteration of the user, re-generate a first image and a second image based on the adjusted current image, transfer the re-generated first image and second image to the 3D projector to generate a new 3D image on the screen, and delete the original 3D image.

2. The system according to claim 1, wherein the 2D animation is set using a multimedia platform.

3. The system according to claim 1, wherein the 3D projector is further operable to generate a 3D virtual scene comprising the user and the original 3D image, the coordinates of the user being the coordinates of the user in the 3D virtual scene, and the coordinates of the original 3D image being the coordinates of the original 3D image in the 3D virtual scene.

4. The system according to claim 1, wherein the 3D camera determines that the position of the original 3D image on the screen needs to be adjusted if the calculated distance is less than a preset value, or determines that the position of the original 3D image on the screen does not need to be adjusted if the calculated distance is greater than or equal to the preset value.

5. The system according to claim 1, wherein the computer adjusts a position of the current image on the display of the computer according to the coordinate alteration of the user by:
obtaining a movement direction and a movement speed of the user according to the coordinate alteration of the user; and
adjusting the coordinates or a size of the current image on the display of the computer according to the movement direction and the movement speed of the user.

6. The system according to claim 5, wherein the computer obtains a movement direction of the user according to the coordinate alteration of the user by:
determining that the movement direction of the user is left if the coordinate alteration of the user in the X-axis is positive, or determining that the movement direction of the user is right if the coordinate alteration of the user in the X-axis is negative;
determining that the movement direction of the user is forward if the coordinate alteration of the user in the Y-axis is positive, or determining that the movement direction of the user is backward if the coordinate alteration of the user in the Y-axis is negative; or
determining that the movement direction of the user is up if the coordinate alteration of the user in the Z-axis is positive, or determining that the movement direction of the user is down if the coordinate alteration of the user in the Z-axis is negative.

7. The system according to claim 6, wherein the computer adjusts the coordinates or the size of the current image on the display of the computer according to the movement direction and the movement speed of the user by:
moving the current image right with the movement speed of the user if the movement direction of the user is left, or moving the current image left with the movement speed of the user if the movement direction of the user is right;
moving the current image down with the movement speed of the user if the movement direction of the user is up, or moving the current image up with the movement speed of the user if the movement direction of the user is down; or
zooming in the current image if the movement direction of the user is forward, or zooming out the current image if the movement direction of the user is backward.

8. The system according to claim 7, wherein the movement speed of the user is calculated by dividing the coordinate alteration of the user by the time interval.

9. A computer-implemented three dimensional (3D) image display method, comprising:
reading an image from a two dimensional (2D) animation stored in a storage device by a computer, the read image being regarded as a current image, and displaying the current image on a display of the computer;
generating a first image and a second image based on the current image by the computer, the first image being a virtual image obtained by a left eye of a user, the second image being a virtual image obtained by a right eye of the user;
transferring the first image and the second image to a 3D projector by the computer;
projecting the first image and the second image on a screen to generate an original 3D image by the 3D projector;
obtaining coordinates of the user and the original 3D image at each time interval by a 3D camera, and calculating a distance between the coordinates of the user and the original 3D image;
determining if a position of the original 3D image on the screen needs to be adjusted according to the calculated distance by the 3D camera, and transferring a coordinate alteration of the user to the computer if the position of the original 3D image needs to be adjusted;
stopping displaying the original 3D image by the computer, and adjusting a position of the current image on the display of the computer according to the coordinate alteration of the user; and
re-generating a first image and a second image based on the adjusted current image by the computer, transferring the re-generated first image and second image to the 3D projector to generate a new 3D image on the screen, and deleting the original 3D image.

10. The method according to claim 9, wherein the 2D animation is set using a multimedia platform.

11. The method according to claim 9, further comprising: generating a 3D virtual scene comprising the user and the original 3D image by the 3D projector, the coordinates of the user being the coordinates of the user in the 3D virtual scene, and the coordinates of the original 3D image being the coordinates of the 3D image in the 3D virtual scene.

12. The method according to claim 9, wherein the step of determining if a position of the original 3D image on the screen needs to be adjusted according to the calculated distance by the 3D camera comprises:
determining the position of the original 3D image on the screen needs to be adjusted if the calculated distance is less than a preset value; or
determining the position of the original 3D image on the screen does not need to be adjusted if the calculated distance is greater than or equal to the preset value.

13. The method according to claim 9, wherein the step of adjusting a position of the current image on the display of the computer according to the coordinate alteration of the user by the computer comprises:
obtaining a movement direction and a movement speed of the user according to the coordinate alteration of the user; and
adjusting the coordinates or a size of the current image on the display of the computer according to the movement direction and the movement speed of the user.

14. The method according to claim 13, wherein the step of obtaining a movement direction of the user according to the coordinate alteration of the user by the computer comprises:
determining that the movement direction of the user is left if the coordinate alteration of the user in the X-axis is positive, or determining that the movement direction of the user is right if the coordinate alteration of the user in the X-axis is negative;
determining that the movement direction of the user is forward if the coordinate alteration of the user in the Y-axis is positive, or determining that the movement direction of the user is backward if the coordinate alteration of the user in the Y-axis is negative; or
determining that the movement direction of the user is up if the coordinate alteration of the user in the Z-axis is positive, or determining that the movement direction of the user is down if the coordinate alteration of the user in the Z-axis is negative.

15. The method according to claim 14, wherein the step of adjusting the coordinates or the size of the current image on the display of the computer according to the movement direction and the movement speed of the user by the computer comprises:
moving the current image right with the movement speed of the user if the movement direction of the user is left, or moving the current image left with the movement speed of the user if the movement direction of the user is right;
moving the current image down with the movement speed of the user if the movement direction of the user is up, or moving the current image up with the movement speed of the user if the movement direction of the user is down; or
zooming in the current image if the movement direction of the user is forward, or zooming out the current image if the movement direction of the user is backward.

16. The method according to claim 15, wherein the movement speed of the user is calculated by dividing the coordinate alteration of the user by the time interval.
